(19) United States
(12) Patent Application Publication
(10) Pub. No.: US 2021/0128285 A1
(43) Pub. Date: May 6, 2021

(54) CIRCULAR FLOSS

(71) Applicant: Vivian Ward, Tumwater, WA (US)

(72) Inventor: Vivian Ward, Tumwater, WA (US)

(21) Appl. No.: 16/669,107

(22) Filed: Oct. 30, 2019

(51) Int. Cl. A61C 15/04

(52) U.S. Cl. CPC A61C 15/041

(57) ABSTRACT

A circular floss, including a circular main body to be inserted through a contact point between teeth to extract at least one food particle therein, and at least one holding surface disposed on at least a portion of the circular main body to facilitate gripping thereof.

### BACKGROUND

### 1. Field

The present general inventive concept relates generally to a floss, and particularly, to a circular floss.

### 2. Description of the Related Art

Conventional usage of dental floss requires a person to open a plastic container, extract dental floss of variable length, and contact the dental floss to a blade to separate it from the plastic container prior to use. In addition to the frustration of this dated method, the dental floss may get tangled or knotted in the process.

Moreover, each end of the dental floss needs to be wound around a finger to provide leverage for a user before the dental floss can be inserted into a mouth of the user. Unfortunately, the dental floss can slip from the finger and/or tying each end together creates a weak connection.

Therefore, there is a need for circular floss that provides leverage without having to wrap around the fingers of the user and has a predetermined length to save on an amount of floss retrieved from a floss container.

### SUMMARY

The present general inventive concept provides a circular floss.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a circular floss, including a circular main body to be inserted through a contact point between teeth to extract at least one food particle therein, and at least one holding surface disposed on at least a portion of the circular main body to facilitate gripping thereof.

The circular main body may include a coating disposed around the circular main body to facilitate movement between the teeth.

The circular main body may deform in response to contact with the teeth.

The coating may be tufted and braided.

The at least one holding surface may be a smooth surface.

The at least one holding surface may be a textured surface.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a top view of a circular floss, according to an exemplary embodiment of the present general inventive concept; and

FIG. 2 illustrates a side perspective view of the circular floss during usage, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

List of Components

Circular Floss 100

Main Body 110

Coating 111

Holding Surfaces 120

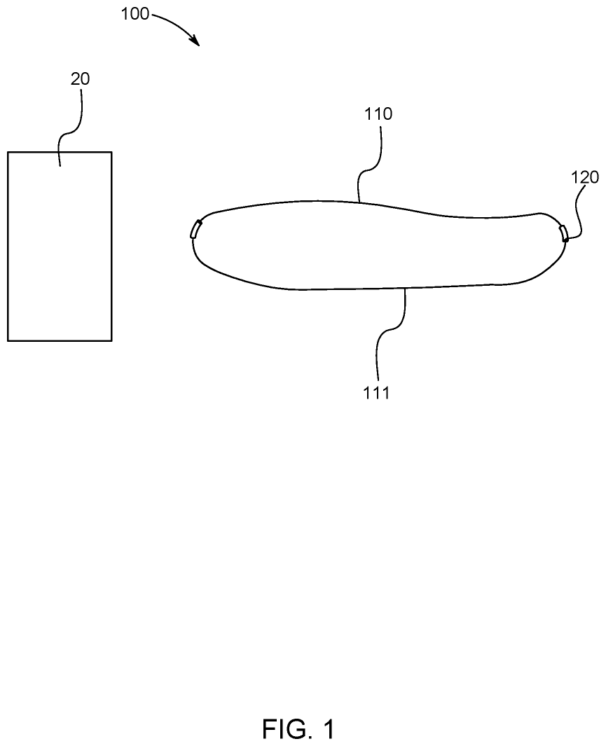

FIG. 1 illustrates a top view of a circular floss, according to an exemplary embodiment of the present general inventive concept.

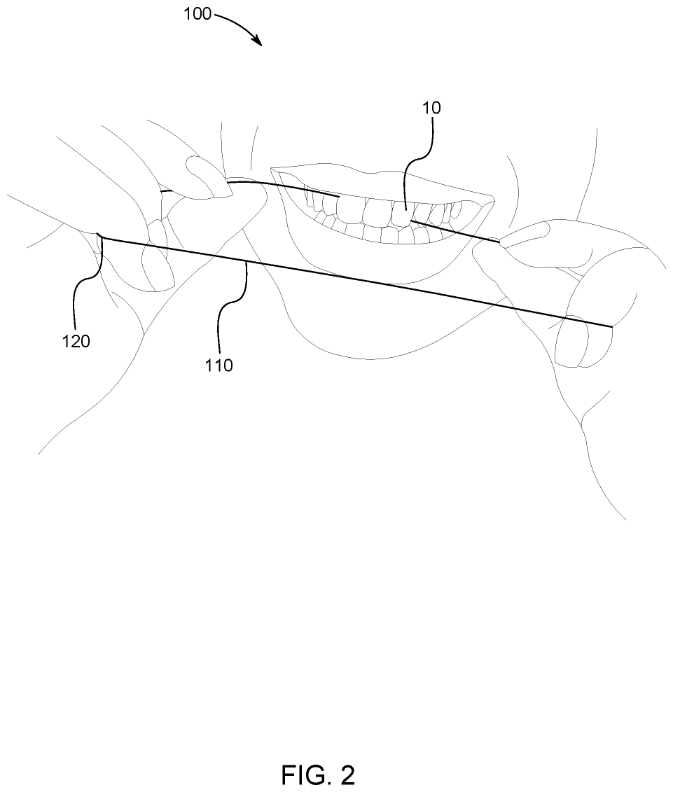

FIG. 2 illustrates a side perspective view of the circular floss during usage, according to an exemplary embodiment of the present general inventive concept.

The circular floss 100 may be constructed from at least one of metal, plastic, and rubber, etc., but is not limited thereto.

The circular floss 100 may include a main body 110 and a plurality of holding surfaces 120, but is not limited thereto.

The main body 110 may include a coating 111, but is not limited thereto.

The main body 110 may have a thin, circular, and/or oval shape with respect to the top view thereof. More specifically, the main body 110 may have a predetermined circumference to fit through a contact point between teeth 10. As such, the main body 110 may be a contiguous body to provide leverage for gripping. As such, the main body 110 may be a fixed size to prevent excess floss from being extracted from a floss container 20.

The main body 110 may have a predetermined diameter. For example, the main body 110 may have a diameter of six inches to eight inches.

Furthermore, the main body 110 may be flexible to bend in response to contact with at least one solid object, movement by a user, and/or the teeth 10 of the user. In other words the main body 110 may deform in response to contact with the at least one solid object, movement by the user, and/or the teeth 10 of the user, such that the main body 110 may surround the teeth 10 of the user.

As such, during use, the main body 110 may be inserted through the contact point between the teeth 10 of the user, and moved between the teeth 10, such that the main body 110 may extract at least one food particle and/or be extracted to remove the at least one food particle therein.

The coating 111 may be circumferentially disposed around the main body 110. The coating 111 may consist of tuft, braiding, oil, and/or wax. The oil and/or wax may provide a flavor, such as cinnamon, mint, peppermint, and/or spearmint. Additionally, the tuft and/or braiding may provide a stiffer portion of the main body 110 to move through a tighter contact point between the teeth 10. Also, the wax may facilitate movement through the contact point.

Each of the plurality of holding surfaces 120 may be disposed around at least a portion of the main body 110. Additionally, each of the plurality of holding surfaces 120 may be disposed along at least a portion of the main body 110, and may have a predetermined length less than a circumference of the main body 110.

Each of the plurality of holding surfaces 120 may be a smooth surface and/or a textured surface to facilitate gripping thereof, such as a plurality of bubbled protrusions extending away therefrom. As such, the user may grip the plurality of holding surfaces 120 during use of the circular floss 100.

Therefore, the circular floss 100 may provide leverage to the user without having to tie a knot using each end. As such, the circular floss 100 may not fall apart due to being a contiguous body. Also, the circular floss 100 may save costs by reducing a length of circular floss 100 extracted from the floss container 20.

The present general inventive concept may include a circular floss 100, including a circular main body 110 to be inserted through a contact point between teeth 10 to extract at least one food particular therein, and at least one holding surface 120 disposed on at least a portion of the circular main body 110 to facilitate gripping thereof.

The circular main body 110 may include a coating 111 disposed around the circular main body 110 to facilitate movement between the teeth 10.

The circular main body 110 may deform in response to contact with the teeth 10.

The coating 111 may be tufted and braided.

The at least one holding surface 120 may be a smooth surface.

The at least one holding surface 120 may be a textured surface.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A circular floss, comprising:
a circular main body to be inserted through a contact point between teeth to extract at least one food particle therein; and
at least one cylindrical shaped holding surface constructed only of metal and disposed on at least a portion of the circular main body to facilitate gripping thereof.

2. The circular floss of claim 1, wherein the circular main body comprises:
a coating disposed around the circular main body to facilitate movement between the teeth.

3. The circular floss of claim 1, wherein the circular main body deforms in response to contact with the teeth.

4. The circular floss of claim 2, wherein the coating is tufted and braided.

5. The circular floss of claim 1, wherein the at least one cylindrical shaped holding surface is a smooth surface.

6. The circular floss of claim 1, wherein the at least one cylindrical shaped holding surface is a textured surface.

7. A circular floss, comprising:
a circular main body to be inserted through a contact point between teeth to extract at least one food particle therein; and
at least one cylindrical shaped holding surface disposed on at least a portion of the circular main body to facilitate gripping thereof, such that the at least one cylindrical shaped holding surface has a diameter larger than a diameter of the circular main body, such that the at least one cylindrical shaped holding surface comprises a plurality of bubbled protrusions extending away therefrom, such that a surface of the circular main body is flush between a boundary of the at least one cylindrical shaped holding surface.
